(19) United States
(12) Patent Application Publication
(10) Pub. No.: US 2009/0097578 A1
(43) Pub. Date: Apr. 16, 2009

(54) Methods for Decoding TPS Carriers in OFDM Systems

(75) Inventors: Junqiang Li, Sunnyvale, CA (US); Baoguo Yang, San Jose, CA (US); Yue Chen, Fremont, CA (US)

Correspondence Address: Venture Pacific Law, PC, 5201 Great America Parkway, Suite 270, Santa Clara, CA, 95054, US

(73) Assignee: AUGUSTA TECHNOLOGY, INC., Santa Clara, CA (US)

(21) Appl. No.: 12/253,015

(22) Filed: Oct. 16, 2008

Related U.S. Application Data
(60) Provisional application No. 60/980,419, filed on Oct. 16, 2007.

(51) Int. Cl. H04L 27/28

(52) U.S. Cl. 375/260

(57) ABSTRACT

The present invention relates to methods for TPS demodulation, frame boundary detection, and TPS decoding. In particular, the present invention relates to a method for finding a frame boundary in demodulating an OFDM signal, comprising the steps of: differentially demodulating each symbol to generate differentially demodulated symbol bits; and finding a sync word position when the scatter pilot position equals zero, wherein the sync word position is set as the frame boundary.

### CROSS REFERENCE

This application claims priority from a provisional patent application entitled “TPS SYNC and Decoder Procedure” filed on Oct. 16, 2007 and having an Application No. 60/980,419. Said application is incorporated herein by reference.

### FIELD OF INVENTION

This invention relates to orthogonal frequency division modulation (“OFDM”) systems and methods, and, in particular, to methods for decoding transmitter parameter signaling (“TPS”) carriers in OFDM systems, and, further in particular to, methods for demodulation, frame boundary detection, and decoding of TPS carriers.

### BACKGROUND

Orthogonal frequency division multiplexing (“OFDM”) is a multi-carrier transmission technique that uses orthogonal subcarriers to transmit information within an available spectrum. Since the subcarriers are orthogonal to one another, those subcarriers can be spaced much more closely together within the available spectrum than, for example, the individual channels in a conventional frequency division multiplexing (“FDM”) system.

In an OFDM system, the subcarriers can be modulated with a low-rate data stream before transmission. It is advantageous to transmit a number of low-rate data streams in parallel instead of a single high-rate stream since low symbol rate schemes suffer less from intersymbol interference (“ISI”) caused by multipath. For this reason, many modern digital communications systems are turning to an OFDM system as a modulation scheme for signals that need to survive in environments having multipath or strong interference. Many transmission standards have already adopted an OFDM system, including the IEEE 802.11a standard, the Digital Video Broadcasting Terrestrial (“DVB-T”), the Digital Video Broadcasting Handheld (“DVB-H”), the Digital Audio Broadcast (“DAB”), and the Digital Television Broadcast (“T-DMB”).

Transmission parameter signaling (“TPS”) carriers are used in OFDM systems to signal parameters related to the transmission scheme, such as channel coding and modulation. This information is used by the receiver to operate the decoding and the demodulation of the signal.

In particular for the DVB-H standard, the TPS data is defined over 68 consecutive OFDM symbols, where these symbols can be referred to as one OFDM frame. Each TPS block, which corresponds to one OFDM frame, contains 68 bits. The bit positions for each block can be defined as follows: 1 initialization bit; 16 synchronization bits; 37 information bits; and 14 redundancy bits for error protection.

The TPS information can be arranged in the following manner as shown in Table 1. The TPS information is transmitted in parallel on 17 TPS subcarriers for the 2K mode, on 34 TPS subcarriers for the 4K mode, and on 68 TPS subcarriers for the 8K mode. The TPS subcarriers convey transmission information including frame number, constellation, hierarchy information, coding rates, guard intervals, and transmission modes to name a few.

TABLE 1

| Bit Number | Purpose/Content |
|---|---|
| s₀ | Initialization |
| s₁-s₁₆ | Synchronization word |
| s₁₇-s₂₂ | Length indicator |
| s₂₃-s₂₄ | Frame number |
| s₂₅-s₂₆ | Constellation |
| s₂₇-s₂₉ | Hierarchy information |
| s₃₀-s₃₂ | Code rate |
| s₃₃-s₃₅ | Encoder type |
| s₃₆-s₃₇ | Guard interval |
| s₃₈-s₃₉ | Transmission mode |
| s₄₀-s₄₇ | Cell identifier |
| s₄₈-s₅₁ | Time interleaver depth |
| s₅₂-s₅₃ | Reserved for future use |
| s₅₄-s₆₇ | Error protection |

If the scattered pilot positions are known in the current symbol, the receiver needs to try up to 17 times for the correlation of a sync word to find the frame boundary. After that, the receiver will demodulate and decode the TPS information. Using this method to find the frame boundary can lead to errors, therefore other methods are needed to find the frame boundary.

### SUMMARY OF INVENTION

An object of this invention is to provide methods for searching for synchronization words bit-by-bit to guarantee better performance.

Another object of this invention is to provide methods for frame boundary detection by searching for the position of a synchronization word.

Briefly, the present invention relates to methods for TPS demodulation, frame boundary detection, and TPS decoding. In particular, the present invention relates to methods for finding a frame boundary in demodulating an OFDM signal, comprising the steps of: differentially demodulating each symbol to generate differentially demodulated symbol bits; and finding a sync word position when the scatter pilot position equals zero, wherein the sync word position is set as the frame boundary.

An advantage of this invention is that synchronization words are searched for bit-by-bit to guarantee better performance.

Another advantage of this invention is that frame boundary detection can be performed by searching for the position of a synchronization word.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates a circular buffer where demodulated data can be stored.

FIG. 2 illustrates a table used to store the calculated values of P(m) for various m, Symbol_cnt(m), and whether a value of m is either an even or odd frame.

### DETAILED DESCRIPTION OF THE PREFERRED EMBODIMENTS

### TPS Demodulation

In order to demodulate TPS carriers, TPS samples within each OFDM symbol will be down-shifted by applying Equation (1), where the SCALE can be defined as 1.0. This operation can also be referred to as down-scaling. Note, the number of TPS subcarriers, N^{TPS}, is 17 for the 2K mode, 34 for the 4K mode and 68 for the 8K mode.

yₙ(i)=round (c_{TPS}ⁿ(i)/SCALE) (1)

where i=0, 1, . . . , N^{TPS}.

The down shifted TPS samples can then be processed by differential demodulation and equal-gain combining.

Differential demodulation can be calculated by,

$${d}_{m} = real ( {\sum }_{i = 0}^{{N}_{TPS}} {y}_{n - 1} ( i ) \cdot {y}_{n}^{*} ( i ) ) \qquad ( 2 )$$

Equal gain combining can then be generated by taking the results of Equation (2) and applying Equation (3). Referring to Equation (3), if dₘ is greater than or equal to zero, then define dₘ as −1. If dₘ is less than zero, then define dₘ as 1 to get the equal gain.

If dₘ>=0, then dₘ=1; Else dₘ=1; (3)

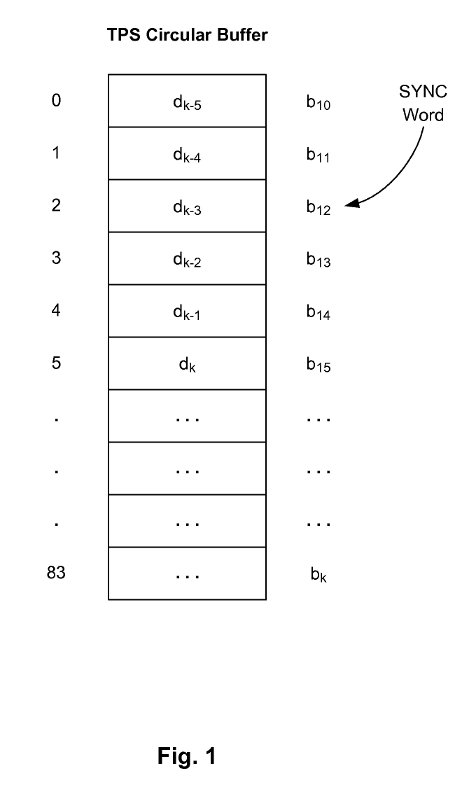

The demodulated data can then be stored in a circular buffer with 68+16 bits. FIG. 1 illustrates such a circular buffer where demodulated data can be stored. Referring to FIG. 1, the TPS circular buffer contains values for the demodulated data, labeled dₖ₋₅ . . . dₖ and so forth, in order of its corresponding bit position for each demodulated data, denoted b₁₀ to bₖ. The synchronization word can begin at a bit position such as b₁₂.

### Frame Boundary Detection

In TPS signaling, there is a 16-bit synchronization word, located in bit positions s1-s16. The frame boundary can be found by searching for the position of the synchronization (“sync”) word. This can be done by correlating the demodulated signal with the local sync word. When the scattered pilot positions in the current frame are known, the sync word correlation is done whenever the scatter pilot position equals 0. There are 17 possible scattered pilot positions in a frame, where a scattered pilot position is repeated every fourth symbol in a frame of 68 symbols. The sync word position is found by searching for the maximum peak value from the 17 possible positions.

$$P ( m ) = \vert {\sum }_{k = cnt - 15}^{cnt} {d}_{k} \cdot {b}_{k - cnt + 1} \vert \\ where \\ {b}_{i} = \{ \begin{matrix}- 1 & if {s}_{i} = 1 \\ 1 & if {s}_{i} = 0\end{matrix} \qquad ( 4 )$$

and dₖ is the differential demodulation. The frame boundary is equal to the maximum of P(m), where m is inclusively from 0 to 16, described in Equation (5).

$$Frame boundary = {arg max}_{m ∈ \{ 0 , … 16 \}} \{ P ( m ) \} \qquad ( 5 )$$

In TPS signaling, there are two reference sync words. One reference sync word is b1-b16=0011010111101110 for the first and third TPS blocks, an odd frame pattern; and the other is b1-b16=1100101000010001 for the second and fourth TPS blocks, an even frame pattern.

$${P}_{max} = {\sum }_{k = cnt - 15}^{cnt} {d}_{k} \cdot {b}_{k - cnt + 1} \qquad ( 6 )$$

When Equation (6) is greater than 0, the current block is the first or third TPS block (i.e., oddeven=1, an odd frame). Otherwise, it is in the second or fourth TPS block (i.e., oddeven=0, an even frame).

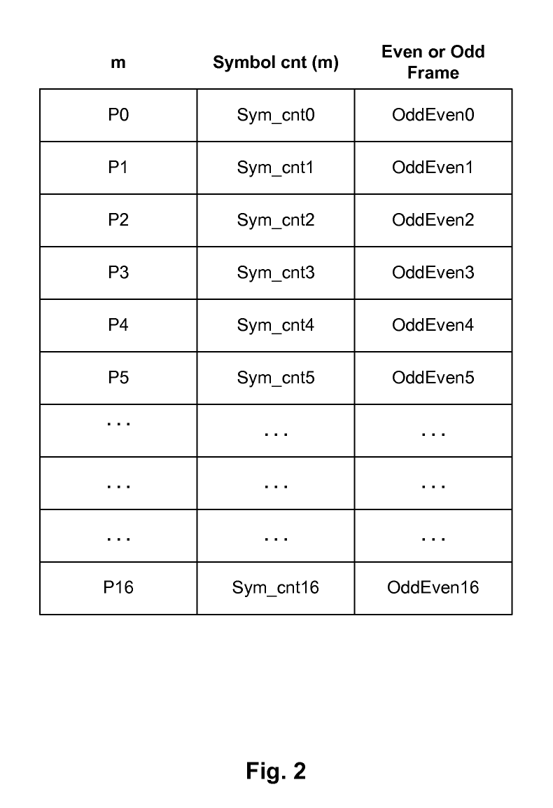

FIG. 2 illustrates a table used to store the calculated values of P(m) for various m, Symbol cnt (m), and whether a value of m is either an even or odd frame. Referring to FIG. 2, the sync word position is located by searching for the maximum peak value from the P0-P16 values, wherein the maximum peak value can be denoted P_max.

By finding the maximum peak value, the “sym_cnt (P_max)” and “oddeven” flags that correspond to that peak value can also be found. The “sym_cnt (P_max)” variable means the symbol index for the last sync word bit (e.g. the 16^{th} bit). Based on the value for the “sym_cnt (P_max)”, a whole frame for a TPS word can be stored in the TPS circular buffer when the current sym_cnt is greater than or equal to the sym_cnt (P_max) plus 51. The “wait_time” parameter can be defined as sym_cnt (P_max) plus 51. By setting the reading point at the TPS circular buffer, an entire TPS word code of 67 bits can be achieved and accessed.

The reading point at the TPS circular buffer can be calculated using a general purpose programming language such as C++, in the following manner:

```
if(sym_cnt == wait_time)
  TPS_cir_buff.update_index_read(−1*(NumInformationBitTPS +
NumParityBitTPS));
else
  TPS_cir_buff.update_index_read(−1*(NumInformationBitTPS +
NumParityBitTPS+(cnt−wait_time)));
```

### TPS Decoding

The TPS synchronization and TPS information, bits s₁-s₅₃, are protected by containing error correction bits, in bits s₅₄-s₆₇, such as BCH code. When the sync word is found and the entire 68 bits are received, it can be sent to an error correction decoder, such as a BCH decoder, for error correction and error detection. For BCH codes in particular, if the sync word's correlation value Pₘₐₓ is less than 16, then some bit values are erroneous. Since the TPS sync words, bits S₁-S₁₆, are known by the receiver, the erroneous bits in the sync word can be corrected before a cyclic redundancy check (“CRC”) check. A bit correction algorithm can be implemented using a general purpose programming language such as C++, in the following manner:

```
if(^{P}ₘₐₓ <16)
{
  if(oddeven)
  {
    for(i=0;i<16;i++)
    rx_bit[i] = tps_sync_bit[0][i];
  }
  else
  {
    for(i=0;i<16;i++)
    rx_bit[i] = tps_sync_bit[1][i];
  }
}
```

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for finding a frame boundary in demodulating an OFDM signal, comprising the steps of:
differentially demodulating each symbol to generate differentially demodulated symbol bits; and
finding a sync word position when the scatter pilot position equals zero, wherein said sync word position is set as the frame boundary.

2. The method of claim 1 wherein the finding sync word step is performed by conducting correlation between the differentially demodulated symbol bits and reference TPS sync words to generate peak values with respect to each position.

3. The method of claim 2 wherein the sync word position is decided by searching for a maximum peak value from the generated peak values.

4. The method of claim 3 wherein an additional step after the finding step is:
replacing the sync word with reference TPS sync word if the maximum peak value is less than the sync word.

5. A method for finding a frame boundary in demodulating an OFDM signal, comprising the steps of:
differentially demodulating each symbol to generate differentially demodulated symbol bits; and
finding a sync word position when the scatter pilot position equals zero by conducting correlation between the differentially demodulated symbol bits and reference TPS sync words to generate peak values with respect to each position, wherein said sync word position is set as the frame boundary.

6. The method of claim 5 wherein the sync word position is decided by searching for a maximum peak value from the generated peak values.

7. The method of claim 6 wherein an additional step after the finding step is:
replacing the sync word with reference TPS sync word if the maximum peak value is less than the syncword.

8. A method for finding a frame boundary in demodulating an OFDM signal, comprising the steps of:
differentially demodulating each symbol to generate differentially demodulated symbol bits;
finding a sync word position when the scatter pilot position equals zero by conducting correlation between the differentially demodulated symbol bits and reference TPS sync words to generate peak values with respect to each position, wherein the sync word position is decided by searching for a maximum peak value from the generated peak values, and wherein said sync word position is set as the frame boundary; and
replacing the sync word with reference TPS sync word if the maximum peak value is less than the syncword.
